(19) United States
(12) Patent Application Publication
(10) Pub. No.: US 2017/0053457 A1
(43) Pub. Date: Feb. 23, 2017

(54) AUTOMATIC LOGIC APPLICATION BASED UPON USER INPUT SHAPES

(71) Applicant: Angle Technologies, Inc., San Francisco, CA (US)

(72) Inventors: Ian Thompson, San Francisco, CA (US); Amir James Tavakoli, San Francisco, CA (US); David Kosslyn, San Francisco, CA (US)

(21) Appl. No.: 15/243,725

(22) Filed: Aug. 22, 2016

Related U.S. Application Data
(60) Provisional application No. 62/207,859, filed on Aug. 20, 2015.

(51) Int. Cl. G06T 19/20; G06T 17/10

(52) U.S. Cl. CPC G06T 19/20; G06T 17/10; G06T 2219/2021

(57) ABSTRACT

A method of automatic logic application comprises receiving input from a user indicating a desire to create a shape, the shape made up of at least three points in an n-dimensional space, detecting the at least three points, and creating a vector set in the n-dimensional space for the at least three points. The method further includes comparing the vector set against a shape classifier of all available n-dimensional shapes to create a match score for each of the n-dimensional shapes, selecting an n-dimensional shape with the highest match score as a selected shape, and identifying a set of control points for the shape, based upon the selected shape. Given the control points and recognized shape, custom logic may be applied to the user-inputted shape.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from U.S. provisional application No. 62/207,859 filed Aug. 20, 2015 and entitled “Virtual Reality Device.”

### BACKGROUND

Field

This disclosure relates to three-dimensional computer environments and more specifically to automatic logic application based upon user input shapes.

Description of the Related Art

There are various techniques for creating three-dimensional shapes in computer environments. Typically, an artist or designer will design an exterior shape, such as the shape of a person. Modern software enables automatic skeleton generation for some artist- or designer-made exterior shapes. For a human design, the internal skeleton may be a stick figure with joints at the appropriate bend points. The designer typically must define joint directions and limits to enable the three-dimensional design software or a game engine to appropriately approximate a human shape when those joints are in motion. Thereafter, that human shape (or other shape) may be capable of human-like animations and movements.

Still other modern software has been demonstrated in an educational environment to be capable of automatically detecting or selecting a pre-defined skeleton based upon the external characteristics of a particular three-dimensional model. Still, these rely upon three dimensional, complex models or, in some cases, on actual pictures or three-dimensional scans of individuals. In both cases, the software is designed as a short-cut to, for example, a video game designer, after he or she has created a three-dimensional model. Even if the automatically-generated skeleton is not exactly correct, it may be adjusted by an artist or designer to be more-correct during the design process.

However, the process of design and rigging is cumbersome, time-consuming, and requires the special skills of a designer or artist. Such a process does not lend itself well to typical user interactions within three-dimensional environments, such as within games. By a typical user here, a three-dimensional game or other environment user is meant, as opposed to an individual in the process of creating or designing a three dimensional environment.

Though, still other modern “games” in three-dimensional environments intentionally enable a great deal of user-created content, including content that alters the three-dimensional environment around the user. Still, that user is reliant upon the software of the three-dimensional environment, not software specifically designed for three dimensional art, animation, or design for the purpose of creating new three-dimensional environment software. As a result, that design software is incredibly complex and provides nearly infinite options of design, whereas user-based changes are typically rather minor and within a predefined set of options.

### DESCRIPTION OF THE DRAWINGS

FIG. 1 is an overview of a three-dimensional environment system.

FIG. 2 is a structural diagram of a computing device.

FIG. 3 is a functional diagram of a three-dimensional environment system.

FIG. 4 is a flowchart of a process of shape characterization identifying a user-input shape and associated control points.

FIG. 5 is a flowchart of processes following shape characterization.

FIG. 6 is a flowchart of a process for identifying a user-input shape.

FIG. 7 is a flowchart of a process for identifying control points in a user-input shape.

FIG. 8, made up of FIGS. 8A and 8B, are visual representations of user-input shapes.

FIG. 9 is a visual representation of a process of shape characterization.

FIG. 10 is a visual representation of a process of training a neural network for use in shape characterization.

FIG. 11 is a visual representation of a process of control point identification.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Enabling users to interact with three-dimensional (or two-dimensional) environments so as to generate interactable objects in real-time while within the three-dimensional environment is desirable to add more interactivity to such environments. For example, should a user desire to have a particular weapon, or to have a companion, to cast a spell, to generate a shape, or to otherwise alter the environment; a user may merely interact with the environment in such a way as to create the desired object or entity.

Smart detection of a simple object or entity created by a user has, until now, been difficult. Still, an increasing number of games, and in particular virtual reality games, desire functionality that enables objects to be created or the world to be manipulated by a user while that user is “within” the game world. So, for example, while within a virtual reality environment, it is desirable not to have to exit the environment in order to create or otherwise generate an object that may appear within the world, seemingly, at will. Still further, it would be ideal if that object can be animated, physics applied, and even complex three-dimensional models automatically selected.

Description of Apparatus

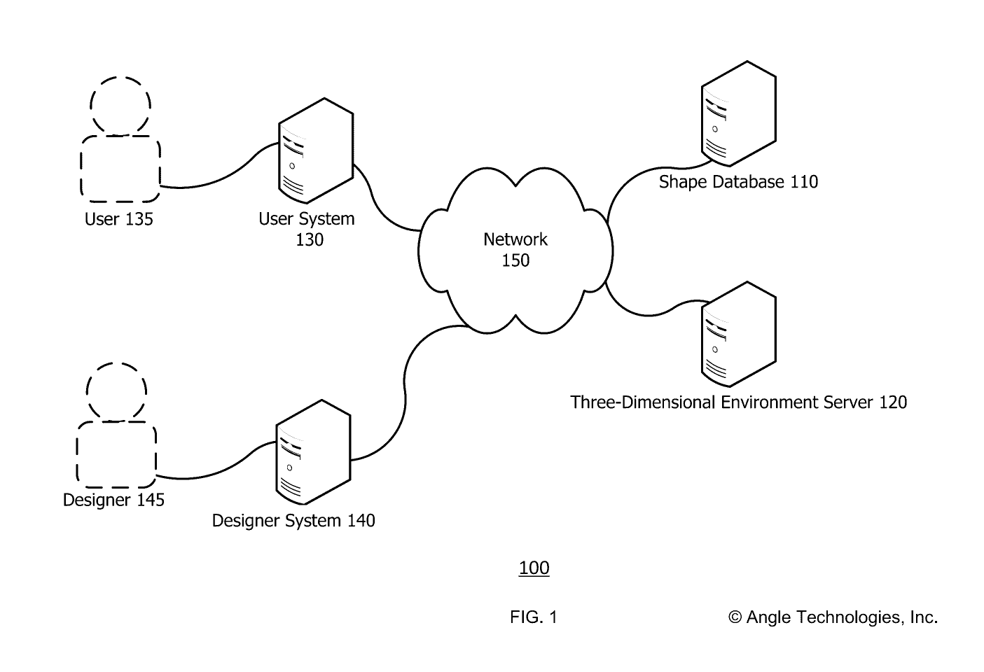

Referring now to FIG. 1 is an overview of a three-dimensional environment system 100. The system 100 includes a shape database 110, a three dimensional environment server 120, user system 130, with an associated user 135, a designer system 140, with an associated designer 145, all interconnected by a network 150.

The shape database 110 is a computing device running relational database software or, as will be discussed more fully below, a neural network trained with many sets of related data so as to be suitable for identifying shapes of a particular type. Although shown separate from the three-dimensional environment server 120 and the user system 130, the shape database 110 may be a part of one or both of those computing devices.

The three-dimensional environment server 120 is a computing device running three-dimensional environment software. This three-dimensional environment software creates an immersive three-dimensional environment into which users or players may enter using avatars or with which users or players may otherwise interact. In some cases, the three-dimensional environment server 120 may operate on a single user's computer providing a three-dimensional environment for that user while other users connect to that user's computer operating as a “server” for their connections. In still other situations, the three-dimensional environment server 120 may operate in a peer-to-peer fashion where a collection of computers maintains the three-dimensional environment.

The three-dimensional environment server 120 is distinct from, for example, the designer system 140, in that a designer may have access to additional, specialized software used to design and create three-dimensional environments, characters, and objects (e.g. Maya® or 3ds Max®) or may have access to software specifically designed for inputting data into the shape database 110. Though the designer may use additional, specialized tools in order to create, once-created, the designer may choose to interact with a three-dimensional environment in much the same way as any other user. Though discussed herein in the context of three-dimensional environments, two-dimensional environments may also be created and enabled for user interaction.

As with the shape database 110, the three-dimensional environment server 120 is shown separately from the shape database 110 and user system 130, but they may be physically and functionally combined with each other in some cases.

The user system 130 is a computing device running software suitable for interaction with a three-dimensional environment served by the three-dimensional environment server 120. When the user system 130 and three-dimensional environment server 120 are physically or functionally combined, the same software operating on the same computing device may create a three-dimensional environment and enable user interaction (e.g. using an avatar or directly) with the three-dimensional environment.

The designer system 140 is a computing device running software suitable for creation of three-dimensional environments and objects (e.g. buildings, streets, avatars, non-player characters, weapons, walls, doors, automobiles, etc.) within a three-dimensional environment. The designer system 140 and the associated software is distinct from the other computing devices and software described herein in that it may be used before a three-dimensional environment is created, in operation, or inhabited by players to create and refine the three-dimensional environment(s) and associated objects and characters within the three-dimensional environment(s).

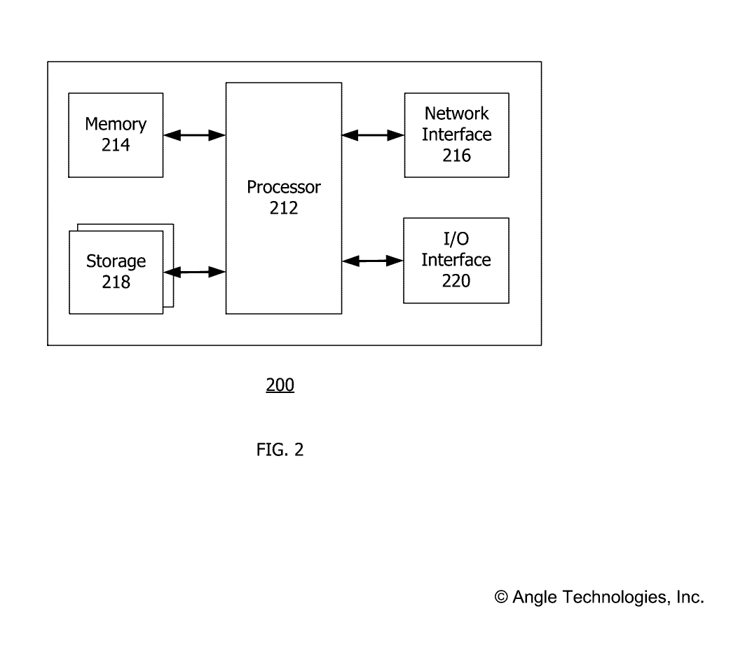

FIG. 2 is a structural diagram of a computing device 200 which is representative of the server computers, client devices, mobile devices and other computing devices discussed herein. The shape database 110, three-dimensional environment server 120, the user system 130, and the designer system 140 are examples of computing devices.

The computing device 200 may include software and/or hardware for providing functionality and features described herein. The computing device 200 may therefore include one or more of: memories, analog circuits, digital circuits, software, firmware and processors. The hardware and firmware components of the computing device 200 may include various specialized units, circuits, software and interfaces for providing the functionality and features described herein.

The computing device 200 has a processor 212 coupled to a memory 214, a network interface 216, storage 218, and an I/O interface 220. The processor may be or include one or more microprocessors, integrated specific function processors (such as video processors), application specific integrated circuits (ASICs), or systems on a chip (SOACs).

The memory 214 may be or include RAM, ROM, DRAM, SRAM and MRAM, and may include firmware, such as static data or fixed instructions, BIOS, system functions, configuration data, and other routines used during the operation of the computing device 200 and processor 212. The memory 214 also provides a storage area for data and instructions associated with applications and data handled by the processor 212. The words “memory” and “storage” as used herein explicitly exclude transitory waveforms and signals.

The network interface 216 includes an interface to a network such as network 150 (FIG. 1). The network interface 216 may be or include a wireless or a wired interface such as Bluetooth®, 802.11x wireless, Ethernet, or other communications interfaces. The network interface 216 may be or include software sufficient to control its own operation.

The storage 218 provides non-volatile, bulk or long term storage of data or instructions in the computing device 200. The storage 218 may take the form of a disk, tape, CD, DVD, SSD (solid state drive) or other reasonably high capacity addressable or serial storage medium. Multiple storage devices may be provided or available to the computing device 200. Some of these storage devices may be external to the computing device 200, such as network storage or cloud-based storage.

The I/O interface 220 interfaces the processor 212 to peripherals (not shown) such as computer monitors, displays, VR headsets, VR or game controllers, displays, keyboards, mice, USB devices and other peripherals.

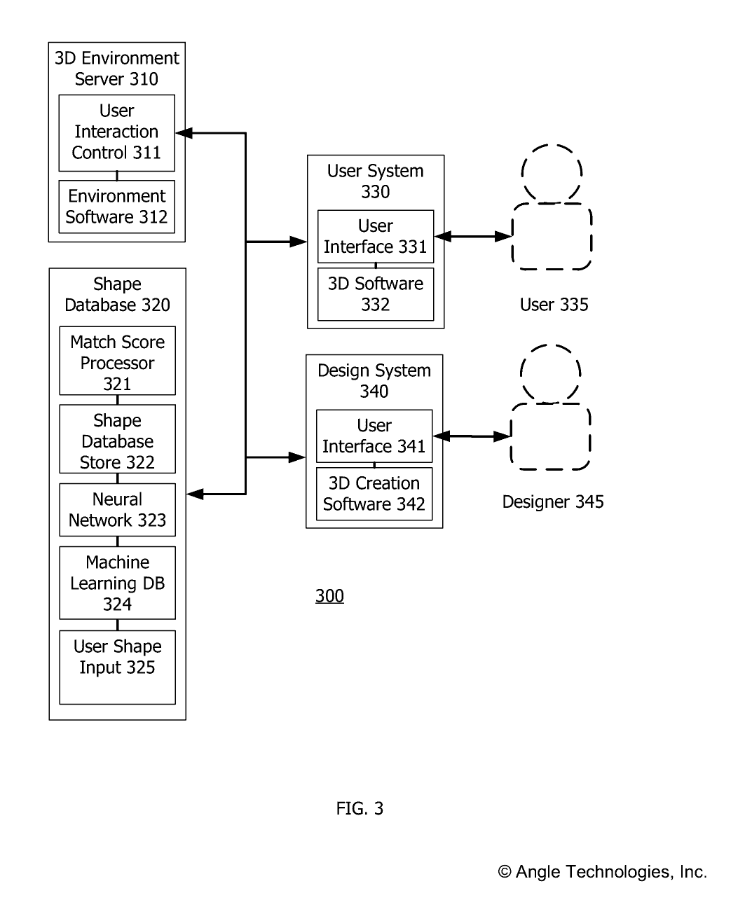

FIG. 3 is a functional diagram of a three-dimensional environment system 300. The three-dimensional environment system 300 includes the three-dimensional environment server 310, the shape database 320, the user system 330, and the design system 340.

The three-dimensional environment server 310 is a computing device (FIG. 2) that includes hardware and software sufficient to generate and enable the operation of one or more three-dimensional environments. As used herein, a three-dimensional environment means a virtual environment created by a computing device that displays and enables interaction and/or movement within the generated three-dimensional environment.

The three-dimensional environment server 310 includes a user interaction control 311 functionality and environment software 312. The user interaction control 311 enables a user to interact with the three-dimensional environment created by the three-dimensional environment server 310. The user interaction control 311 may include tracking user avatar movement within the created three-dimensional environments and tracking user interaction with the three-dimensional environment such as acting upon objects, characters, and spaces within the three-dimensional environment (e.g. opening doors, picking up objects, interacting with non-player characters within the environment). The user interaction control 311 may also include tracking of user interaction with control devices such as VR headsets, VR controllers, game controllers, keyboards and mice that may be or may have an effect on the three-dimensional environment. As discussed more-fully below, the user interaction monitored by the user interaction control 311 may include actions that are designed to create or manipulate objects within the three-dimensional environment.

The environment software 312 is responsible for enabling the creation of one or more three-dimensional environments, objects and non-player characters within those three-dimensional environments. The environment software may include specialized components for enabling detailed or complex lighting, physics, puzzles, mini-games, and other, similar functionality within the three-dimensional environment.

The environment software 312 may react to data from the user interaction control 311 to thereby cause the three-dimensional environment provided to a user system 330 to change. For example, the scenery or “room” within the three-dimensional environment may change as a result of user interaction with the user interaction control 311. Virtual doors may open or conversation may be had with non-player characters to advance a story or scene within the three-dimensional environment.

The three-dimensional environment server 310 may operate as a server available on a local area network (LAN) or over the Internet to which other computing devices with suitable software for interacting with the three-dimensional environment server 310. The user system 330, described below, may be one such computing device, combining the functionality of the user system 330 and the three-dimensional environment server 310 into a single computing device. The three-dimensional environment server 310 may enable multiple computing devices to connect simultaneously and, thereby, to interact with one another within the created three-dimensional environment.

As indicated above, the three-dimensional environment server 310 functionality may be integrated into the same user system or other computing device described herein. In such cases, the three-dimensional environment server 310 may actually be a user system 330 (discussed below) or other computing device and may or may not enable others to connect for simultaneous interaction with and within the three-dimensional environment or environments created by the three-dimensional environment server 310.

The shape database 320 is a computing device that includes a match score processor 321, a shape database store 322, and may include a neural network 323, a machine learning database 324, and a user shape input 325. The shape database 320 includes software functionality that enables the shape database 320 to identify user-input shapes within the three-dimensional environment. In order to accomplish this goal, the shape database 320 may include one or more of the components described below.

The match score processor 321 includes software with the primary function of determining whether or not and, if so, which shape within the shape database store 322 most-closely matches that of a user-input shape within the three-dimensional (or as a variation, a two-dimensional) environment. The match score processor 321 is responsible for selecting the appropriate matching process to use, applying the process, and then completing the comparison so as to select the most-likely shape within the shape database store 322 associated with the user-input shape.

The shape database store 322 is a database that stores a set of data suitable to identify a user-input shape as a shape of a particular type. For example, in three-dimensional space, a shape of a particular type may be defined as a set of points at which vectors connect (e.g. a cross may be two lines intersecting near the top of the vertical line at a single point). A shape of a particular type may be defined as a set of vertices with particular directions, intersections, and rotations. Of course, when performing shape matching, the sets of points or sets of vertices may be rotated, scaled, or transformed in order to perform shape matching. The shape database store 322 may also be a more-complex data set made up of the results of the learning of a neural network 323 or trained by user shape input 325.

The shape database store 322 may also store three-dimensional models (e.g. of a cross or of a human) associated with simplified shapes. The shape database store 322 may also store animation associated with the three-dimensional models or with two- or three-dimensional shapes input by a user. So, if a particular shape is identified by the match score processor 321 as a particular type of shape, then an associated three-dimensional model or animation may be associated with that shape. For example, if a user-input shape is identified as a human shape (e.g. a stick figure), then a three-dimensional or two-dimensional model of a human may be stored within the shape database store 322 for replacing the user-input stick figure. An animation of the stick figure or the three-dimensional or two-dimensional model may also be associated with that particular shape within the shape database store 322. The three-dimensional environment server 310 may, thereafter, replace a user-input shape with an associated shape in the shape database store 322 and the associated animation for that shape.

The neural network 323 is a concept in computer software that enables software to “learn” based upon the application of a large data set. For example, a neural network 323 may be trained to recognize a “sword” or a “human” or a “face” through training by providing neural network 323 with thousands or hundreds of thousands or millions of examples of each of a “sword” a “human” and a “face”. Thereafter, the neural network 323 may be used to identify those user-input shapes that have been trained based upon the “knowledge” gained by the neural network 323 from the training. The neural network may be trained with a large data set at the outset or may be taught through machine learning.

The machine learning database 324 may be the storage location for data learned by the neural network 323. In machine learning, the neural network 323 is taught, over time, by users who identify shapes and correct the shape database 320. Eventually, the neural network 323 is trained.

The user shape input 325 enables users to manually input a specific shape or to correct a selected shape identified by the shape database 320.

The shape database 320 may be integrated into the user system 330, the three-dimensional environment system 310 in other embodiments.

The user system 330 is a computing device that includes a user interface 331 and three-dimensional software 332.

The user interface 331 enables user interaction with the user system 330 and, by extension, with the three-dimensional software 332. The user interface 331 includes software and hardware sufficient to enable a user 335 to interact with the three-dimensional software 332. Specifically, the user interface 331 may include game controllers, keyboards, mice, virtual reality headsets, virtual reality controllers, mobile phones, touch-screen displays, and other user interface devices. These devices may be considered a part of the user system 330.

The three-dimensional software 332 enables the user system 330 to generate a three-dimensional environment with which the user 335 can interact using the user system 330. The three-dimensional software 332 may be integrated entirely with the three-dimensional environment server 310, as discussed above. Alternatively, the three-dimensional software 332 may enable the user system 330 to interact with the three-dimensional server 310 to thereby display and enable interaction with the three-dimensional environment.

The design system 340 is a computing device including software used by a designer 345 to create three-dimensional environment software 312, three-dimensional environments, models, and animations used within three-dimensional environments.

To accomplish these tasks, the design system 340 includes a user interface 341 and three-dimensional creation software 342. The user interface 341 enables the designer 345 to enable interaction with the design system 340. The three-dimensional creation software 342 enables a designer 345 to create three-dimensional environments, three-dimensional models, and animations.

Description of Processes

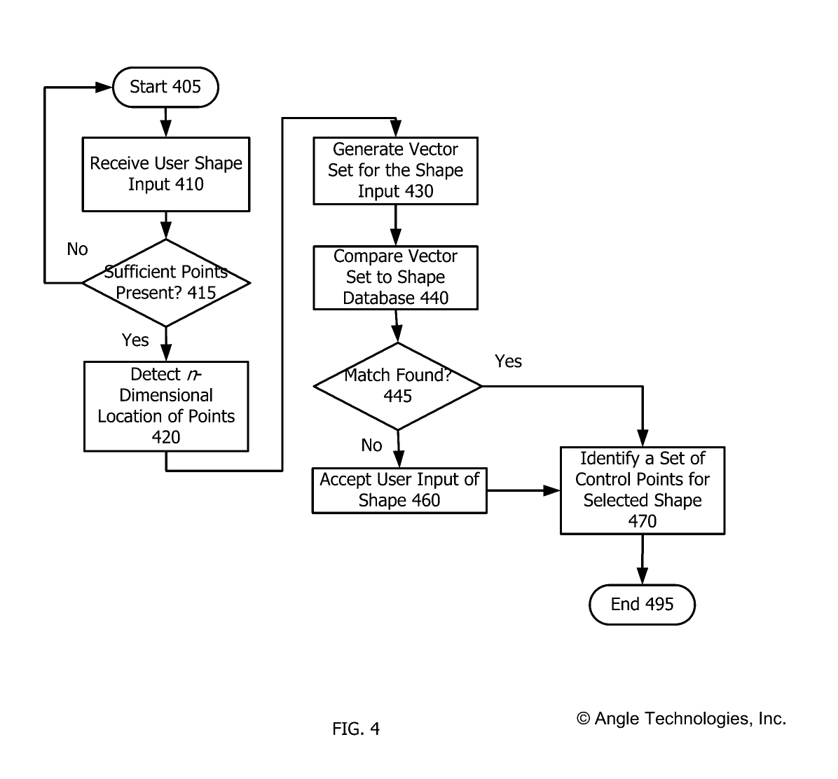

Referring now to FIG. 4 a flowchart of a process of shape characterization identifying a user-input shape and associated control points. The process begins at start 405 and ends at end 495. However, the process may be cyclical taking place many times within a two- or three-dimensional environment.

After the start 405, the user interaction control 311 of the three-dimensional environment server 310 (FIG. 3) receives user interaction indicating that a user wishes to input a shape at 410. The user interaction may be, for example, a user depressing a particular button or key, while making movements with a cursor controlled by a mouse or with his or her hands or while holding a motion-tracking controller or visually-tracked by a camera or infrared sensor(s). Nonetheless, this user input demonstrates a user's intent to input a new shape.

Thereafter the match score processor of the shape database 320 first determines whether or not there are sufficient data points present at 415 to enable the match score processor to identify a shape. Though described as “points,” the test may not look for individual points within the user-input shape. Instead, the test may be for a total volume, a number of voxels, a set of vertices and triangles, a set of vectors or a set of vector points or various other input characteristics. The test is primarily intended to determine if there is sufficient input by the user from which to derive a user-input shape using the methods described herein. This step may be optional in some implementations.

If insufficient points are present (“no” at 415), then the process returns to the start 405. If there are sufficient points present (“yes” at 415), then the n-dimensional location of those points is detected at 420. This process may work in two or three dimensions, but regardless, the points (or vectors or voxels or the like) location in n-dimensional space are detected so as to identify the user input shape as clearly as possible for shape matching.

Next, a vector set for the shape input is generated at 430. At this point, the user input shape is converted to a series of vectors so that shape matching may be performed on those vectors. Vectors are easier to match, and user input may be tracked as to direction and the way in which a shape was input by the user. This data may aid the match score processor 321 in matching the vectors to a particular shape.

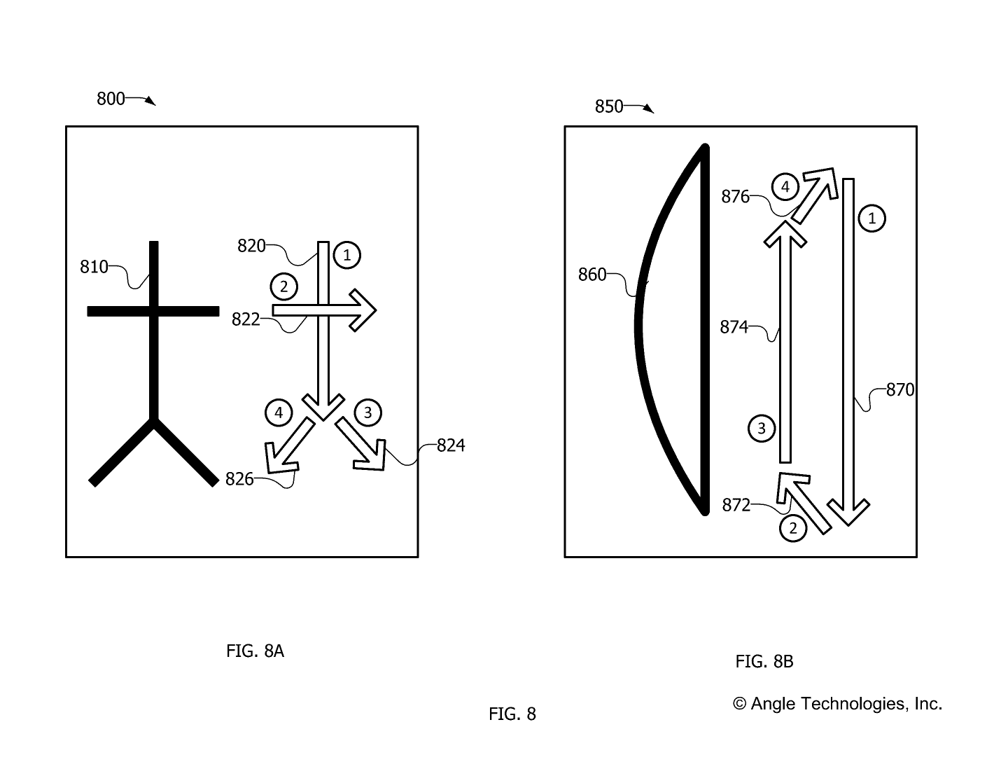

Turning briefly to FIG. 8, made up of FIGS. 8A and 8B, a set of vectors in two dimensions for specific user input shapes are shown. First, regarding FIG. 8A, a human stick figure is shown at 810 within environment 800. The stick figure may be identified by a series of user input “brush strokes” that may also serve as an associated vector set for the stick figure. First, a downward stroke 820 for the body in three- or two-dimensional space is made, for example by a mouse cursor or a motion-tracking controller. Next, a cross-stroke 822 is made for the arms. Then, two leg strokes 824 and 826 are made, one for each leg.

Similarly, as shown in FIG. 8B, a bow 860 is shown within environment 850. The first vector 870 may be a downward stroke for the bow string. The second vector may be an upward, angled stroke 872 for part of the bow itself, followed by an upward stroke 874 and an upward and inward stroke 876 for the rest of the bow.

The actual user input that results in either of the stick FIG. 810 or bow 860 may be tracked when that user is inputting the shape so that a vector set may be created, as described above at 430 for later comparison with the shapes stored in the shape database store 322.

Though the examples of FIGS. 8A and 8B are intentionally simple, much more complex user-input shapes may be created by a user. Likewise, though described as vectors, at a mathematical level, the user-input shapes may be represented in software in numerous ways. For example, many modern games that enable “world building” functionality similar to that of Minecraft® rely upon the capability of a user to create and destroy and in some cases to move “voxels”. A voxel is a shorthand term for a three-dimensional “pixel” within a three-dimensional world. In addition, voxels are often capable of having characteristics associated with them at various levels of abstraction. For example, a voxel may have a color (e.g. “brown”) and may have a type (e.g. “stone”) and may have a specific name or still-more specific type (e.g. “steel ore”). Voxels may also have properties like action—e.g. a hinge voxel may allow connected voxels on either side to move in a particular fashion when acted upon. Having these characteristics enables computers and players to operate upon those voxels using a known set of rules or logic (discussed below). The voxels themselves may inherit that logic from their types, colors, names and the like. Voxels may employ multiple inheritances from multiple sources.

Voxels also typically have either a definite or relative location in a three-dimensional environment. These locations may be described as a location within a three-dimensional array or other, similar means. As a result, the “location” of a group of voxels as they are placed by a user may be ascertained. If they are assembled by a user using an indicator within the software that indicates that the shape being drawn is intended to be a shape that will gain certain properties once-completed, that indicia may be provided to the user-input shape as the shape is created and it may act as a property or type of the created shape. Then, a shape database 320 may be employed to ascertain that shape based, in part upon the relative location, any other types, names or characteristics applied to that user-input shape by the user. So, in this situation, the user may not literally draw vectors within the air of a three-dimensional environment, but instead may build an object (perhaps adding to and deleting from along the way) using various voxels. A voxel-based shape may be acted upon in much the same way as described herein with respect to vectors. Likewise, the junctions between two voxels may be identified as corresponding to (or likely to correspond to) control points—thus making the process of identifying and applying logic to control points (discussed more fully below) more efficient.

Likewise, although FIGS. 8A and 8B are shown as line vectors with a beginning point and end point and a direction, the user-input shapes may actually be mapped in a more complex manner. For example, splines may be used. Splines are mathematical lines formed as the result of several, joined polynomial functions. The polynomial functions meet at junction points, also known as spline points. If multiple splines are used to describe a shape, those splines may also meet at junction points. One benefit of splines, as will be discussed more fully below, is that because of the included junction points, splines lend themselves well to control point mapping.

For example, the bow shown in FIG. 8B has a total of only four vectors. A spline may represent the entire bow in a single spline with a first segment corresponding to the first vector 870, but the next segment being a curved line described as a polynomial that may cover the entire curve of the bow or cover it in several segments to more-accurately reflect the user-input shape. Once the spline for a user-input shape is created, it automatically includes a series of segments with junction points between them. As it turns out, when mapping control points for an identified shape to a user-input shape identified as a spline, the control points often map exactly or near-exactly to the junction points (or immediately between junction points) in the spline. Thus, merely by representing user-input shapes (and storing shapes in the shape database 320) as splines is an efficient way to perform the processes and methods described herein. This will be discussed more fully below.

Finally another representation this invention affords is a traditional polygonal mesh. Traditional graphics render objects as composed of triangles with vertices. An application may allow a user to sculpt, by adding, removing and moving around vertices and triangles based on user interaction, such that their actions can create new shapes. There are many approaches to creating a new shape based on sculpting (e.g.: Marching Cubes, Dual Contouring, manually adjusting vertices and triangles, etc). Once these user-made shapes are created, they may be analyzed for control points on the mesh (e.g. at a vertex or between vertices), in a similar process to voxels or splines, described above.

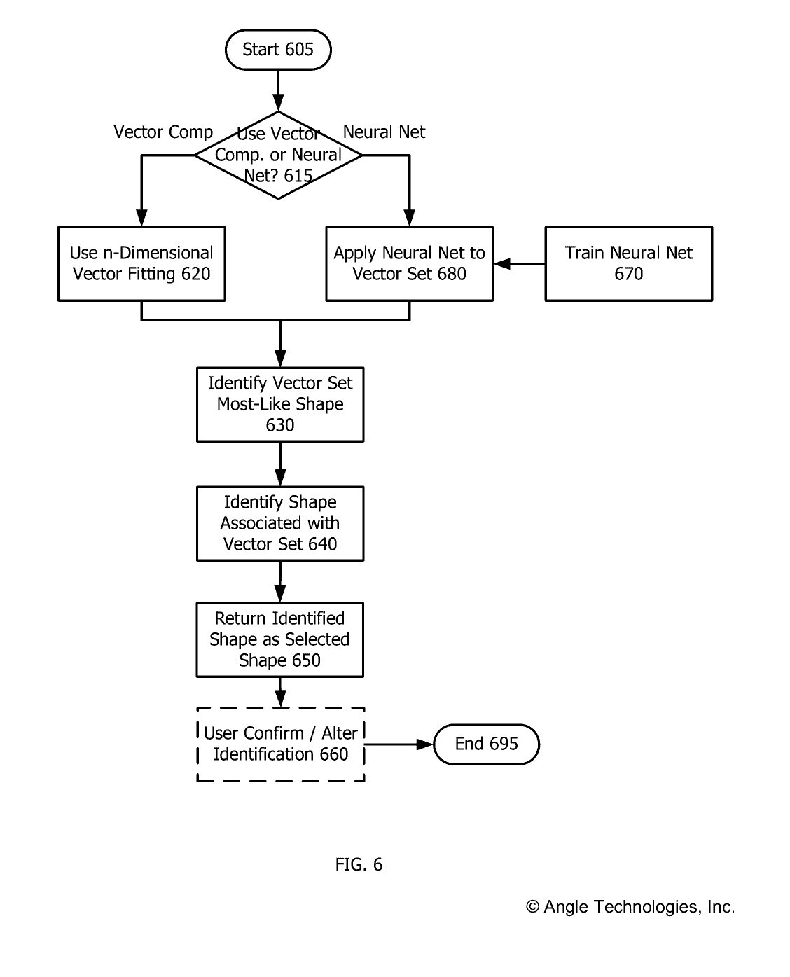

Returning to FIG. 4, the vector set is compared to a set of known shapes in the shape database store 322. This process, described below in FIG. 6 may take several forms. Specifically, a vector comparison may be performed or a neural network may be used to perform the shape comparison. In either case, the vector set is compared to the shape database store 322 in order to find the most-likely shape that corresponds to the user input shape.

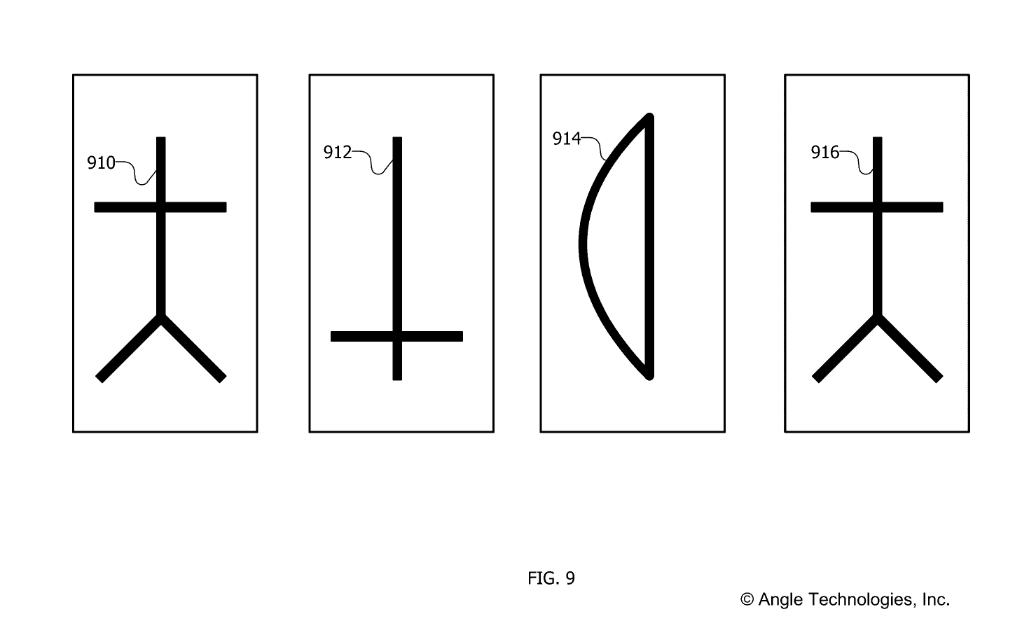

Turning briefly to FIG. 9, a visual representation of a process of shape comparison is shown. This comparison is intentionally very simple. In reality, a database of thousands or hundreds of thousands or millions of shapes may be checked. Here, a user-input shape 910 that has been converted into a vector set is shown. A series of shapes from the shape database store 322 may be seen. The first shape 912 is an inverted cross that is intended to correspond to a “sword”. If a user draws this shape, a “sword” set of physics, animations, and interactions may be loaded from the shape database store 322. The second shape 914 is a bow. Similarly, if this shape is selected, then physics, animations, and actions related to a bow and arrow may be loaded. Finally, a stick figure of a human is the third shape 916. If this shape is elected, then physics, animations, and actions for a human shape may be loaded from the shape database store 322.

Returning again to FIG. 4, a determination whether a match is found is made at 445. This determination may be made, for example, by the match score processor 321. As a preliminary step, vector sets in the shape database store 322 that are of a sufficiently-large threshold k difference from the user input shape may be excluded without further consideration.

If no match is found (“no” at 445), then user input of a shape may be accepted at 460. In this step, a user interacting with a three-dimensional environment who desire to input a shape may be asked to choose the shape from a set of available shapes through a user-friendly set of prompts requested within the three-dimensional environment. In this way, even when the matching process is inadequate to identify the shape, the match score processor 321 may be taught about new shapes. Further, the user will be less-likely to be frustrated by a failure of the match score processor 321 to find a shape within the shape database store 322 if the user is able to identify the selected shape within the shape database store 322. The “selected shape” is the shape identified as most-likely to correspond to the user input shape.

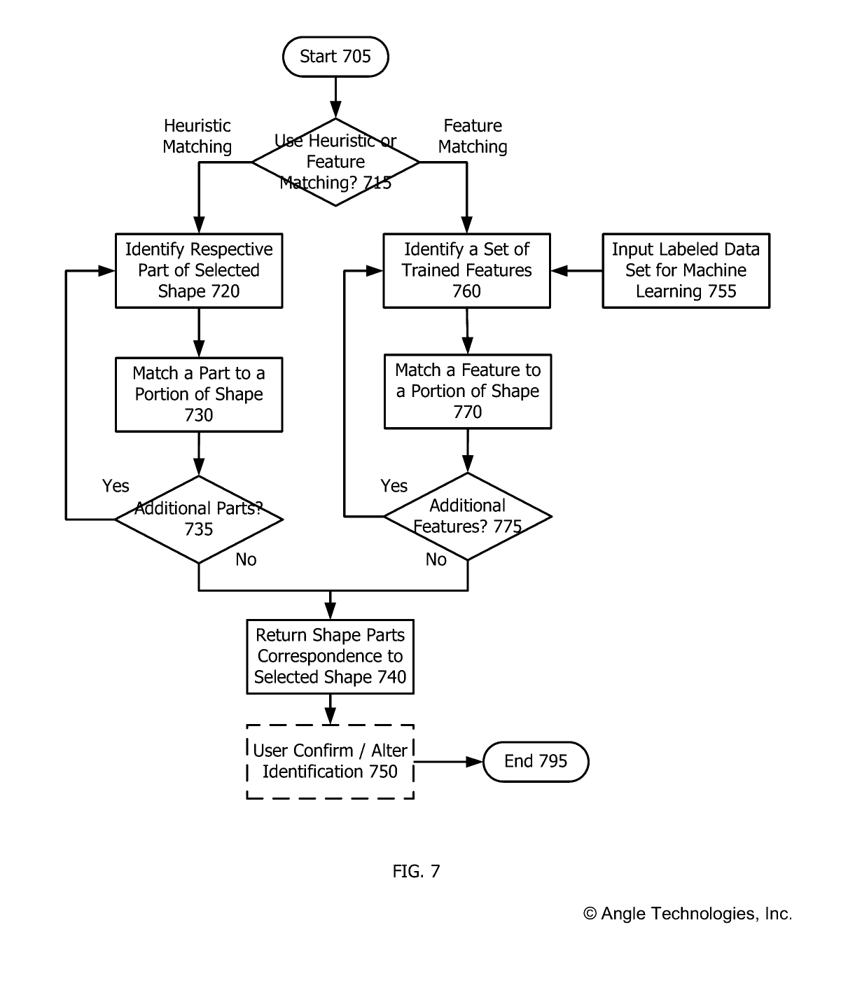

If a match is found (“yes” at 445), then the final process, described below with respect to FIG. 7, is to identify a set of control points for the selected shape at 470. The phrase “control points”, as used herein means points where multiple lines of a skeletal structure for the selected shape intersect and for which action or rotation is associated with the selected shape. For example, “control points” for a human stick figure may be the joints as the intersection of the arms and legs with the body. In more complex models, there may be joints for every, or, most intersections. If an identified shape is a bow and arrow, then control points may be the bow string attachment points or bow string itself because those points move with respect to the selected shape. The process then ends at 495.

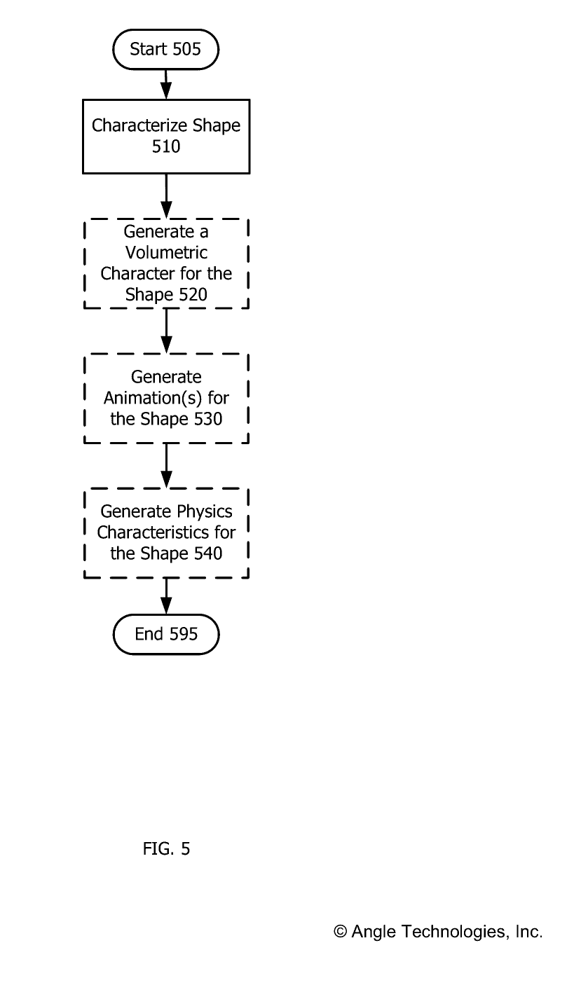

FIG. 5 is a flowchart of processes following shape characterization. The process begins at start 505 and ends at end 595. However, the process may be cyclical taking place many times within a two- or three-dimensional environment.

After the start 505, the shape is characterized at 510 such that a selected shape is identified. This corresponds to the process described above with respect to FIG. 4. Next, three optional steps are shown. The steps are shown in dashed lines to indicate that each is optional.

First, a volumetric character for the selected shape may be generated at 520. At this step, data may be loaded from the shape database store 322 related to a volumetric character associated with the selected shape. Here, a three-dimensional model may be generated in the three-dimensional environment in response to the identification of a selected shape corresponding to that model. For example, if a stick figure is identified, it may be ascertained that the user intended to create a human. Accordingly, a three-dimensional model of a human may be substituted for the user input stick figure. Similarly, a three-dimensional sword may be substituted for a stick-sword made of only two strokes.

Next, animations for the selected shape may be generated at 530. In this situation, a user-drawn shape may be left exactly as it is (or created as a volumetric model), but may be detected to be, for example, a human stick figure or a bow. In response, associated animations may be imputed to the stick figure so that it can walk and interact with a user within a three-dimensional environment. Similarly, a bow may be animated such that it may be “shot” toward a target or otherwise interacted with by a user within the three-dimensional environment.

Finally, physics may be generated for the characteristics of the selected shape at 540. Here, a stick figure (or volumetric model) may be given a weight and associated actions. So, for example, if the stick figure is pushed over, it may interact with the environment in which it is found. A bow may drop to the floor rather than floating in mid-air after being drawn.

Then, the process ends at 595.

FIG. 6 is a flowchart of a process for identifying a user-input shape. This flowchart corresponds to step 440 in FIG. 4 above. The process begins at start 605 and ends at end 695. However, the process may be cyclical taking place many times within a two- or three-dimensional environment.

After the start 605, a determination is made whether to use vector comparison or a neural network. This determination may actually be made well in advance, for example by a designer selecting the preferred method of performing shape matching. Alternatively, a user of the three-dimensional environment may select one or the other. Finally, multiple comparisons may occur in parallel with the scores from each of them used in combination (eg: average, min or max) when making the final evaluation. Similarly, though only two methods are identified here, multiple methods may be used (eg: spatial clustering algorithms, creating hashes of the input and comparing those, etc). If other methods are employed, then those may be selected at this stage.

If vector comparison is to be used (“Vector Comp” at 615), then n-dimensional vector fitting is applied 620. Here, after the user input shape is converted into a series of vectors, then that user-input vector is compared against a database of stored n-dimensional vectors stored in the shape database store 322. When doing this comparison, the match score processor 321 may compare vector sets including things like: colors of the vector (selected by a user inputting the vector), density or sparsity of vectors, total bounding volume, alignment, center of volume, center of mass, or raw data about the creation itself such as pixel values, vertex values, voxel values, volume distributions across a grid, and other, similar characteristics of a user input shape. The vector set that best-matches the user input vector set is selected.

So, in cases of iconic structures, people, spells, uniforms, and the like, the fact that user input is a particular color and has a particular vector density may be most-relevant for finding a match. For example, a fire hydrant is virtually always red. A dense, low center of mass, packing of red-colored vectors with several vectors making out “studs” pointing outward from near the top of the dense, low center of mass, packing may most-closely match that of a fire hydrant as opposed to a blue vector set of similar shape that may correspond to a U.S. post box, which are typically blue. Virtually any measurable aspect of a user-input set of vectors may be used to perform better matching.

If a neural network is to be used (“Neural Net” at 615), then a neural network is used to match vector sets at 680. First, however, the neural network must be trained at 670. In training, either a user inputs a set of data or a set of a series of previously-identified shapes are fed to the neural network 323 in order to train the neural network 323. This may be, for example, a predetermined data set in which each of the vector sets in the data set are identified as associated with one of a set of shape types. So, for example, thousands of vector sets characterized as “human” may be uploaded. These vector sets may be stick figures, may be complex three-dimensional characters, or may be any number of shapes associated with a “human”. By training the neural network in this way, a larger set of data is available to the neural network in performing comparisons so as to identify a user input shape as associated with a particular type of shape—in this case, “human.”

The neural network may employ a number of different implementations. There may be a Neural Network with any number of node layers and connectivity, with different numbers of “Hidden” nodes and corresponding weightings. Different configurations may be better at recognizing some shapes than others. For example, some model configurations may naturally be better at detecting a smaller number of simpler shapes, whereas others might be better-suited to handle noise and many small shapes embedded in a bigger object better. Dedicated networks may be employed for specific features, such as having one model specifically trained to recognize handwriting or text characters with its parameters and training data specifically designed to do well for those types of input. Still other networks may be specifically trained for two-dimensional or three-dimensional input or inputs by a user that include few distinct vectors while other networks are employed for complex vector sets. A coarse shape detection algorithm may be used to first identify the general type of shape (e.g. handwriting or a person or a weapon) before instructing another specific neural network to perform an analysis of the shape so as to characterize it (e.g. the word “cow”, a male wearing armor, or a bow). The benefit of this is a range of neural network types may be used where each can be optimized for specific types of classification.

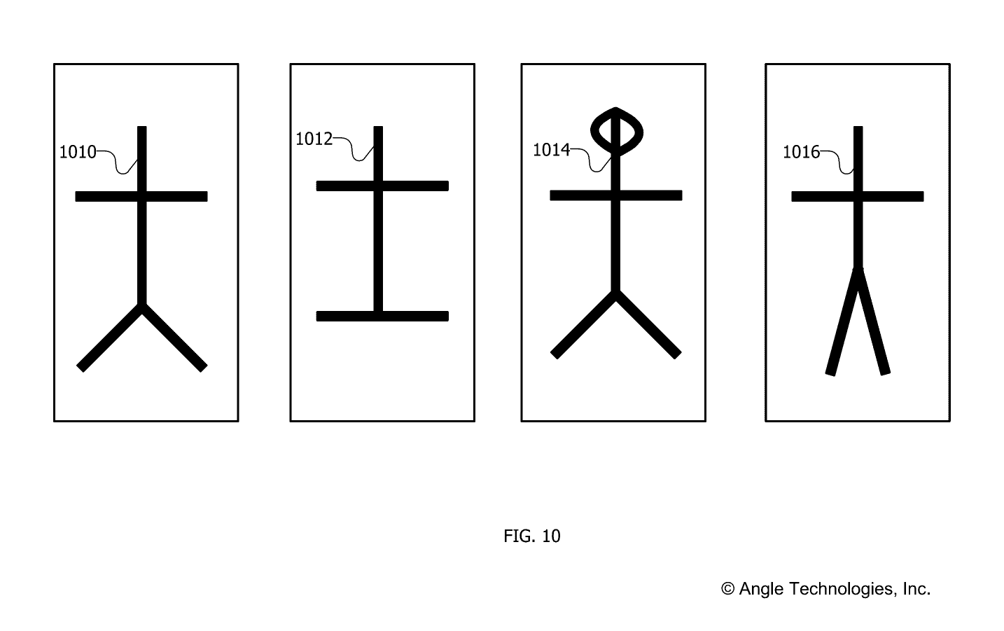

Turning briefly to FIG. 10, a visual representation of a process of training a neural network for use in shape characterization is shown. The series of shapes shown in FIG. 10 are each examples of “human” that may be used to train a neural network. Although this example is intentionally simplified, each of FIGS. 1010, 1012, 1014 and 1016 represent a “human” stick figure. A much-larger database including these images along with thousands more, some of which may be three-dimensional characters, some of which may be humanoid, but not human, and the like may all be used to train a neural network 323.

Returning now to FIG. 6, once trained, the neural network 323 may be applied at 680 to identify a user input shape as a selected shape. If properly trained, the neural network 323 should identify user input shapes quite well.

Thereafter, the vector set most likely to be the selected shape is identified at 630. Here, the vector set that is most like the vector set input by the user is identified.

Next, the most likely shape, that with the highest match score created by the match score processor 321, is identified as the selected shape at 640. As discussed above, that selected shape may have characteristics such as animations, volumetric models, physics, or arbitrary scripts that should execute if it is selected or interacted with by a user in a particular way or at all (e.g. a bow may fire arrows, a gun may fire bullets, a door may open, a non-player character may interact with a player character, etc), with any number of arbitrary properties such as health, speed, personality, and the like.

The most-likely shape and its corresponding characteristics are returned as the selected shape at 650.

Thereafter, a user may (optionally—as shown in dashed lines), be asked to confirm or be provided with the opportunity to alter the identification 660). Then, the process may end at 695. At this point the characteristics and information from the recognition will either be passed into the control point system (see below), or take immediate effect (e.g. a user-input circle may be given weight and be affected by gravity because it is recognized by the three-dimensional environment server 310 as a rock that should have weight on which gravity acts, as a property of that identified shape).

FIG. 7 is a flowchart of a process for identifying control points in a user-input shape. This process has a start 705 and an end 795, but may take place many times over the operation of and user interaction with a three-dimensional environment. This process is designed to identify the control points for which user interaction or animations may be provided.

After the start 705, a determination is made whether to use heuristic matching or feature matching at 715. This determination may be made by a user 335 in real-time or may be predetermined by a designer 345 or beforehand by a user 335. Alternatively, both may be executed and their results may be used in combination such that the result with more confidence or an average of the results may be used to select an identified shape.

If heuristic matching is to be used (“Heuristic Matching” at 715), then a listing of parts of the selected shape is identified at 720. For example, a human body has a head, arms, and legs. For a bow, there is a curbed bow and a string. For a sword, there is a hilt and a blade and a handle. For each of these, there may be precise hand-coded algorithms to identify the control points for that shape. For example, the heuristic matching algorithm may understand that “hips” for a human shape should have three things connected to it, namely, two legs and one chest. Similarly, a bow shape may be known to have a bent bow portion and a straight string portion, with the string portion connected to two ends of the bow portion. These types of characteristics may be coded for virtually any shape type.

Then, each in turn, the typical characteristics of the selected shape are matched to a portion of the user input shape at 730. For example, the hilt of a sword may be identified by matching the characteristics of the selected shape to those of the user-input shapes.

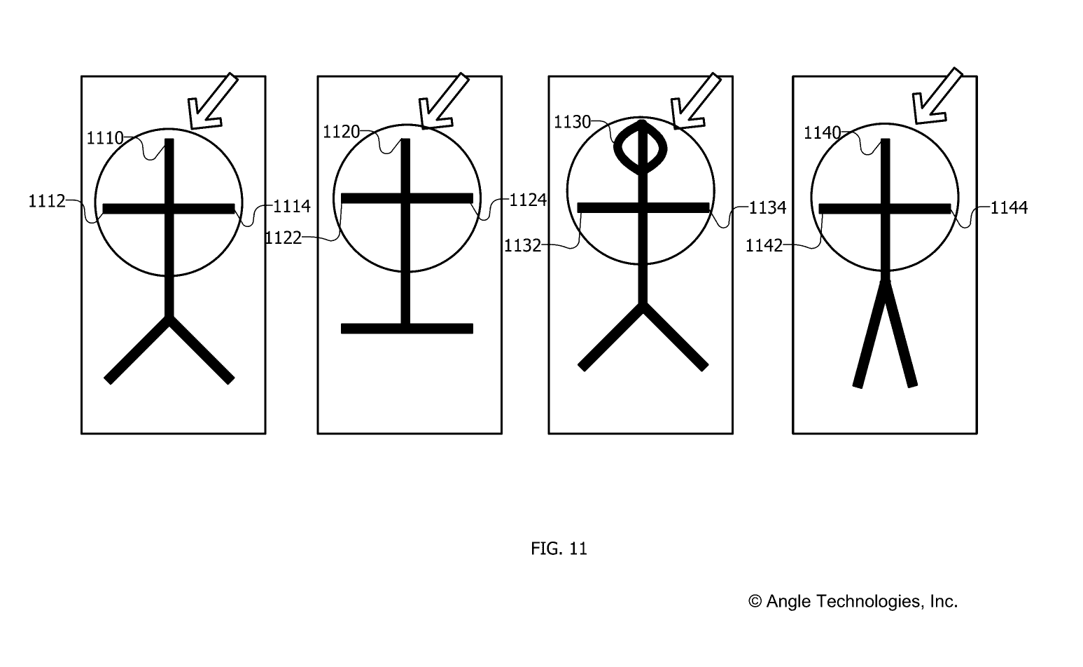

Turning briefly to FIG. 11, a visual representation of control point identification. Here, the user input shape is shown as a stick figure human. The “head” 1110 has a number of typical characteristics. For example, it is a terminating point, it appears above the characteristics identified as “arms” 1112, 1114 or above a vector crossing the vector that terminates in the “head” 1110.

The heuristic matching may rely upon this similarity of head 1120, above arms 1122, 1124; head 1130 above arms 1132, 1134; and head 1140 above arms 1142, 1144. In such a way, that because the head 1110 has characteristics matching those of a “head” as shown in each of the examples of a human.

As discussed briefly above, the use of splines, voxels, or polygons may enable the identification of these control points much faster and more efficient than mere reliance upon vectors themselves. Splines, voxels and polygons inherently have junction points. So, if a user has input a shape and it has been identified using a spline or a voxel, then the shape database 320 may incorporate data indicating which junction points (or relative distances between junction points) of the associated spline, voxel, or polygon are those for which a particular set of logic, traits, animations, or physics applies. In this way, the mapping of characteristics from a shape identified in the shape database 320 as applying to a user-input shape may be made more efficient and faster than through reliance upon a vector-only based system. In the vector-based system, the control points, if any, must be identified on a user-input shape in the relative space of the user-input shape. Such applications of control points may be less-accurate, more computationally-complex, and less pleasing to a user than those using voxels, splines, or polygons.

Returning to FIG. 7, a determination is then made whether there are still further parts of the selected shape at 735. If so, (“yes” at 735), then the process returns to 720.

If not (“no” at 735), then the process continues and returns the respective shape parts corresponding to those of the selected shape at 740. These control points may be used, for example, to animate a user input shape, to create a volumetric shape, or to supply physics.

The user may be provided with an opportunity to confirm or alter the identification of the control points at 750. Then, the process ends at 795.

If feature matching is to be used (“Feature Matching” at 715), then a set of trained features are identified at 760. However, these features must have previously been input as a labeled data set to enable machine learning at 755. Specifically, machine learning may be used in conjunction with a large, labeled data set to teach the machine learning database 324 each of the associated features. The labeled features may be a series of shapes each labeled appropriately. For example, a series of “swords” may have each of the blade, hilt, and handle labeled appropriately.

Once trained at 755, the set of trained features may be identified in a user input shape of a particular type at 760.

For such a shape, the trained features may be matched to a portion of the shape at 770. So, for each of the blade, hilt, and handle in the trained shape at 755, those features are matched in the selected shape at 770.

If there are additional features (“yes” at 775), then the identification and matching continues at 760. If there are no additional features (“no” at 775″) then the process continues at 740, discussed above. That discussion above will not be repeated here.

The abstract shape (e.g. a “sword”) training data may be supplied with object characteristics that may interact with the three-dimensional environment or enable interaction with the three-dimensional environment after the identification. For example, gravity may affect an object once created. An object may have scripts or animations automatically begin, such as a created puddle of water in mid-air may fall to the ground and appear to pool or flow as it should flow based upon gravitational effects. Likewise, windows and doors may be locked or able to be opened and have associated animations with their opening, the forcing of the locks, or the breaking of the window or door.

Identified shapes may also have logic added to one or more specific control points, once those control points have been identified. The word “logic” as used herein means an algorithm, a set of arbitrary instructions that a shape should follow, a set of movement- or environment-based characteristics, or an interactive response tied to a particular identified shape or to a control point or control points of a particular identified shape. The logic controls the way in which the user or environment interacts with or responds to the shape, once identified.

For example, if the training data allows the three-dimensional environment 310 and shape database 320 to recognize the hilt, and the hilt may have a script added that ensures that a player character avatar or non-player character avatar may only pick up the sword below the hilt. Similarly, a human shape, such as a stick figure may be able to swivel a head from side to side within an approximately 180 degree range, but cannot indefinitely circle his or her head round and round because this does not match the logic of a “head” once that head has been identified. These control point specific pieces of logic may be stored in the shape database store 323 of the shape database 320 in association with each shape in the database 320 so that they may be applied once a particular shape has been recognized.

FIG. 11 is a visual representation of a process of control point identification.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method of automatic logic application to user input shapes comprising:
receiving input from a user indicating a desire to create a shape, the shape made up of at least three points in an n-dimensional space;
detecting the at least three points;
creating a vector set in the n-dimensional space for the at least three points;
comparing the vector set against a shape database of all available n-dimensional shapes to create a match score for each of the n-dimensional shapes;
selecting an n-dimensional shape with the highest match score as a selected shape;
identifying a set of control points for the shape, based upon the selected shape; and
applying logic to the shape from the shape database based on the selected shape and the set of control points.

2. The method of claim 1 further comprising excluding from consideration each of the n-dimensional shapes whose match score falls below a predetermined threshold.

3. The method of claim 1 further comprising automatically identifying a selected one of (a) a volumetric character for the shape corresponding to the selected shape and the set of control points, (b) a set of animations for the shape corresponding to the selected shape and the set of control points, and (c) a set of physics characteristics for the shape corresponding to the selected shape and the set of control points.

4. The method of claim 1 wherein the logic applied includes at least one selected from the group: applying a name to the shape, applying a type to the shape, applying a weight to the shape, applying a color to the shape, applying an action to the shape, applying a function to the shape, applying an object feature to the shape, applying a hardness to the shape, making an interaction available with the shape, applying a set of dialogue to the shape, applying a texture to the shape, and applying an action to the shape.

5. The method of claim 1 wherein the input is received from a user interacting within a computer generated three-dimensional or two-dimensional environment.

6. The method of claim 1 wherein comparing the vector set against the database of all available n-dimensional shapes to create the match score for each of the n-dimensional shapes includes a selected one of (a) reliance upon a vector comparison of the shape to a plurality of vector shapes in the shape database, the plurality of vector shapes represented as a series of n-dimensional vectors and (b) a neural network comparison wherein the shape database is a neural network that has been trained in shape characteristics of various shape types.

7. The method of claim 6 wherein the identifying a set of control points further comprises identifying specific parts of the selected shape by using a selected one of (a) a heuristic process designed to search a database for a selected shape and to identify the corresponding control point of a selected shape that most-likely matches a specific part of the shape and (b) a comparison of previously-input user shapes to the shape so as to feature match a control point of the selected shape onto characteristics of the shape based upon the previously-input user shapes.

8. Apparatus comprising a storage medium storing a program having instructions which when executed by a processor will cause the processor to:
receive input from a user indicating a desire to create a shape, the shape made up of at least three points in an n-dimensional space;
detect at least three points;
create a vector set in the n-dimensional space for the at least three points;
compare the vector set against a database of all available n-dimensional shapes to create a match score for each of the n-dimensional shapes;
select an n-dimensional shape with the highest match score as a selected shape;
identify a set of control points for the shape, based upon the selected shape; and
apply logic to the shape based upon the selected shape and the set of control points;

9. The apparatus of claim 8 wherein the instructions further cause the processor to exclude from consideration each of the n-dimensional shapes whose match score falls below a predetermined threshold.

10. The apparatus of claim 8 wherein the instructions further cause the processor to automatically generate a selected one of (a) a volumetric character for the shape corresponding to the selected shape and the set of control points, (b) a set of animations for the shape corresponding to the selected shape and the set of control points, and (c) a set of physics characteristics for the shape corresponding to the selected shape and the set of control points.

11. The apparatus of claim 8 wherein the logic applied includes at least one selected from the group: applying a name to the shape, applying a type to the shape, applying a weight to the shape, applying a color to the shape, applying an action to the shape, applying a function to the shape, applying an object feature to the shape, applying a hardness to the shape, making an interaction available with the shape, applying a set of dialogue to the shape, applying a texture to the shape, and applying an action to the shape.

12. The apparatus of claim 8 wherein the input is received from a user interacting within a computer generated three-dimensional environment.

13. The apparatus of claim 8 wherein the instructions further cause the processor to compare the vector set against the database of all available n-dimensional shapes to create the match score for each of the n-dimensional shapes includes a selected one of (a) reliance upon a vector comparison of the shape to a plurality of vector shapes in the shape database, the plurality of vector shapes represented as a series of n-dimensional vectors and (b) a neural network comparison wherein the shape database is a neural network that has been trained in shape characteristics of various shape types.

14. The apparatus of claim 13 wherein the instructions further cause the processor to identify a set of control points by identifying specific parts of the selected shape by using a selected one of (a) a heuristic process designed to search a part database for a selected shape and to identify a control point of a selected shape that most-likely matches a specific part of the shape and (b) a comparison of previously-input user shapes to the shape so as to feature match a control point of the selected shape onto characteristics of the shape based upon the previously-input user shapes.

15. The apparatus of claim 8 further comprising:
the processor
a memory
wherein the processor and the memory comprise circuits and software for performing the instructions on the storage medium.

16. A method of automatic logic detection and application comprising:
receiving input from a user indicating a desire to create a shape, the shape made up of at least three points in an n-dimensional space;
detecting the at least three points;
creating a spline in the n-dimensional space for the at least three points;
comparing the spline against a shape database of all available n-dimensional shapes to create a match score for each of the n-dimensional shapes;
selecting an n-dimensional shape with the highest match score as a selected shape;
identifying a set of control points for the shape, based upon the selected shape, at least one of the set of control points corresponding to a junction point along the spline; and
applying a logic to the shape as a result of the identification of the selected shape and the set of control points.

17. The method of claim 16 wherein applying logic includes a selected one of applying animation to the shape, or enabling user interaction with the shape based upon characteristics provided as a result of the identification of the selected shape and the set of control points.

18. The method of claim 17 wherein the animation is an action performed by the shape a result of the identification of the shape as a selected shape.

19. The method of claim 16 wherein the comparing the spline against the database of all available n-dimensional shapes to create the match score for each of the n-dimensional shapes includes a selected one of (a) reliance upon a vector comparison of the shape to a plurality of vector shapes in the shape database, the plurality of vector shapes represented as a series of n-dimensional vectors and (b) a neural network comparison wherein the shape database is a neural network that has been trained in shape characteristics of various shape types.

20. The method of claim 19 wherein the identifying a set of control points further comprises identifying specific parts of the selected shape by using a selected one of (a) a heuristic process designed to search a part database for a selected shape and to identify a control point of a selected shape that most-likely matches a specific part of the shape and (b) a comparison of previously-input user shapes to the shape so as to feature match a control point of the selected shape onto characteristics of the shape based upon the previously-input user shapes.
